(19) United States
(12) Patent Application Publication
(10) Pub. No.: US 2010/0331455 A1
(43) Pub. Date: Dec. 30, 2010

(54) Soluble Plant Fiber Product And Method Of Making The Same

(76) Inventor: Tien Jen Lo, Dongguan City (CN)

Correspondence Address: Dr. BANGER SHIA;Patent Office of Bang Shia, 102 Lindencrest Ct, Sugar Land, TX, 77479-5201, US

(21) Appl. No.: 12/492,881

(22) Filed: Jun. 26, 2009

(51) Int. Cl. C08L 3/02; C09K 3/00

(52) U.S. Cl. 523/447; 252/183.11; 524/52; 524/47; 252/183.13

(57) ABSTRACT

A soluble plant fiber product and method of making the same, wherein the product comprises, by weight, the following ingredients: plant fiber power 40-80%, bonding agent 2-40%, demoulding agent 5-15%, starch 5-40%, and preferably further comprises 0.1-2% dye powder. This technology reduces the environmental pollution while improving the utility value of the raw material. The resultant product is fully degradable, nontoxic and has a low cost. The present invention provides a better processability by essentially and structurally changing the configuration of the plant fiber. The resultant product conforms to the relevant international test standards, such as U.S.A./Europe food testing standard, and can pass the microwave oven and dishwasher tests and is suitable for automatic production.

### BACKGROUND OF THE INVENTION

1. Field of the Invention

The present invention relates to a soluble plant fiber product and method of making the same, and more particularly to a plant fibrous made soluble plant fiber product and method of making the same.

2. Description of the Prior Art

With the global industrialization, environmental pollution, especially the so-called white pollution has become a very important problem which can not be ignored. After use, disposable plastic products (including foam plastic food container, package material, plastic bag, film, agricultural plastic film) are mostly discarded in the natural environment, mainly in the tourism resorts, both sides of the river or road, farmland, lake and pond, and every corners of the cities and towns, which not only spoils the visual environment as visual pollution, but also cause direct or indirect damage to the natural environment since the plastic products are not degradable. Recent researches show that there are a certain amount of residual styrene monomers in the polystyrene-made disposable form plastic food containers, which is detrimental to human health. Hence, many developed countries have restricted the use of plastic in the food package or required to do coating treatment to the surface of the food package. However, the plastic fast-food containers are still being used on a large scale in Taiwan.

On the other hand, many natural plan fibrous materials, such as bamboo powder, wood powder, sugarcane bagasse, rice hull powder, reed residue and wheat bran, are usually discarded or burned as wastes, causing serious environment pollution, or simply used as fertilizers or feeds which have a relatively low utility value. The present invention is aimed at waste recycling and utilization and reducing environment pollution.

The present invention has arisen to mitigate and/or obviate the afore-described disadvantages.

### SUMMARY OF THE INVENTION

The present invention is aimed at waste recycling and utilization and reducing environment pollution by providing a soluble plant fiber product and method of making the same. The product of the present invention comprises, by weight, the following ingredients: plant fiber powder 40-80%, bonding agent 2-40%, demoulding agent 5-15%, starch 5-40%, and preferably further comprises 0.1-2% dye powder.

The plant fibrous powder is selected from the group consisting of bamboo powder, wood powder, sugarcane bagasse, rice hull powder, reed residue and wheat bran. The bonding agent is selected from the group consisting of polyvinyl alcohol, poly-e-caprolactone, hydroxypropyl methylcellulose, epoxy resin, amino resin, phenolic resin.

The demoulding agent is selected from the group consisting of Calcium Stearate and zinc stearate. The starch is natural starch or modified starch. The dye powder is selected from the group consisting of chrome powder, cadmium powder, iron powder, cobalt powder, titanium powder, Prussian blue, carbon black, quinacridone, Quinacridone Magenta, Quinacridone Red, azo dye powder, hansa yellow, disazo yellow, Permanent Yellow, permanent red, Naphthol Red, aniline black, sbnigrosine spirit soluble, Oil-soluble Aniline Black, BW, oil blue, and Alkali blue. The product includes tableware, film, shaped material, pot or bowl adopted for flowers and plants. The fineness of the plant fibrous powder is 40-100 mesh.

A method for making a soluble plant fiber product comprising the steps of:

weighing the respective ingredients and dehydrating at 60-80 Celsius degrees for 1-5 hours;

grinding the ingredients into powder and mixing them round;

pressing the resultant mixture into a semi-product; and grinding flash off the semi-product to obtain a final product.

The method can further comprise a disinfection step as required, preferably, the disinfection step is to disinfect the product for 30-60 minutes by UV light.

Based on many years of experiences, the inventor of the present invention invented a method of making a soluble plant fiber product by using plant fibrous material, which reduces the environmental pollution while improving the utility value of the raw material. The resultant product is fully degradable, nontoxic and has a low cost. The present invention provides a better processibilty by essentially and structurally changing the configuration of the plant fiber. The resultant product conforms to the relevant international test standards, such as U.S.A./Europe food testing standard.

Furthermore, the bonding agents of the present invention can be degradable, such as polyvinyl alcohol and poly-e-caprolactone, or non-degradable, such as hydroxypropyl methylcellulose, epoxy resin, amino resin and phenolic resin. Using different bonding agents in the production process can get different products with different characteristics. The products using the degradable agent are disposable products which cannot be used repeatedly and start to grow mildew after one and half months being discarded in natural environment, and 60-70% of the product can be degraded after 3 months. These products cannot pass the microwave oven and dishwasher tests. The products using the non-degradable agent can be used repeatedly, starch should be added during the production process, which will break the molecular chain of the bonding agent. The products using the non-degradable agent start to grow mildew after being embedded in the ground and will be . . . ,

and 60-70% of the product can be degraded after one year. These products can pass the microwave oven and dishwasher tests.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

For a better understanding of the present invention, reference should be made to the following embodiments.

First embodiment: a plant fibrous product which is degradable within three months and can not pass the microwave oven or dishwasher test.

A soluble plant fiber product of the first embodiment of the present invention is made by the following steps:

1, grinding bamboo into bamboo powder with a fineness of 60 mesh and taking out 60 kg bamboo powder as a raw material;

2, putting 5 kg polyvinyl alcohol, 10 kg poly-e-caprolactone and 10 kg HPMC into a container (putting 2 kg HPMC into 5 kg water which is maintained at 90 Celsius degrees and heating for one hour, taking 5 kg water solution), mixing round and then adding the bamboo powder and 15 kg natural starch, mixing round again while adding 10 kg zinc stearate, dehydrating the resultant mixture at 70 Celsius degrees for 3 hours and then grinding it into fine powder;

3, pressing the mixture into a semi-product with a hot pressing machine at 150 Celsius degrees and the pressure of 10 kg/cm² for 2-5 minutes, releasing steam in the first minute and then continue the pressing for 1-8 minutes, and the duration of the pressing is determined by the desired thickness of the semi-product;

4, grinding flash off the semi-product manually or with an electric grinding wheel to obtain a final product;

5, packaging the final product, and doing the packaging under an UV light if the final product needs to be sterilized, required facilities are UV disinfection device and packaging equipment.

Tests show that tableware products made by the method of the first embodiment of the present invention start to grow mildew after one and half months being discarded in natural environment and 60-70% of the products can be degraded after 3 months. These products cannot pass the microwave oven and dishwasher tests.

A soluble plant fiber product of a second embodiment of the present invention is made by the following steps:

1, grinding wood material into wood powder with a fineness of 40 mesh and taking out 40 kg wood powder as a raw material;

2, putting 5 kg poly-e-caprolactone into a container and blending it and then adding the wood powder and 40 kg modified starch, mixing round again while adding 5 kg zinc stearate and 2 kg cadmium dye powder and permanent yellow dye powder, dehydrating the resultant mixture at 60 Celsius degrees for 5 hours and then grinding it into fine powder;

3, pressing the mixture into a semi-product with a hot pressing machine at 160 Celsius degrees and the pressure of 30 kg/cm² for 2-5 minutes, releasing steam in the first minute and then continue the pressing for 1-8 minutes, and the duration of the pressing is determined by the desired thickness of the semi-product;

4, grinding flash off the semi-product manually or with an electric grinding wheel to obtain a final product;

5, packaging the final product, and doing the packaging under an UV light if the final product needs to be sterilized, required facilities are UV disinfection device and packaging equipment.

Tests show that the product of the second embodiment of the present invention starts to grow mildew after one and half months being discarded in natural environment and 60-70% of the products can be degraded after 3 months. These products cannot pass the microwave oven and dishwasher tests.

A third embodiment: a plant fibrous product which is degradable within one year and can pass the microwave oven or dishwasher test.

A soluble plant fiber product of the third embodiment of the present invention is made by the following steps:

1, grinding rice hull into rice hull powder with a fineness of 100 mesh and taking out 80 kg rice hull powder as a raw material;

2, putting 10 kg amino resin and 20 kg epoxy resin into a container and blending and then adding the rice hull powder and 5.9 kg starch, mixing round again while adding 15 kg Calcium Stearate and 0.1 kg Phthalocyanine, during this process, we found that after putting hydroxypropyl methylcellulose, epoxy resin, amino resin, phenolic resin into the raw material and blending for one hour, the temperature of the whole raw material will increase over 40 Celsius degrees and the resin will be volatilized, hence, a cooling process is required to ensure the processability, and then grinding the resultant mixture into fine powder;

3, pressing the mixture into a semi-product with a hot pressing machine at 170 Celsius degrees and the pressure of 40 kg/cm² for 2-5 minutes, releasing steam for two times in the first minute, and the duration of the pressing is determined by the desired thickness of the semi-product;

4, grinding flash off the semi-product manually or with an electric grinding wheel to obtain a final product;

5, packaging the final product, and doing the packaging under an UV light if the final product needs to be sterilized, required facilities are UV disinfection device and packaging equipment.

Tests show that the product of the third embodiment of the present invention starts to grow mildew after 6 months being discarded in natural environment and 60-70% of the products can be degraded after one year. These products can pass the microwave oven and dishwasher tests and can be used repeatedly.

A fourth embodiment: a plant fibrous product which is degradable within one year and can pass the microwave oven or dishwasher test.

A soluble plant fiber of the third embodiment of the present invention is made by the following steps:

1, grinding reed residue into reed powder with a fineness of 100 mesh and taking out 70 kg rice hull powder as a raw material;

2, putting 10 kg amino resin, 10 kg epoxy resin, 5 kg phenolic resin and 15 kg hydroxypropyl methylcellulose into a container, blending and then adding the reed powder and 5.0 kg starch, mixing round again while adding 5 kg Calcium Stearate, 10 zinc stearate and 1 kg BBC, dehydrating the resultant mixture at 80 Celsius degrees for 1 hour and then grinding the resultant mixture into fine powder;

3, pressing the mixture into a semi-product with a hot pressing machine at 170 Celsius degrees and the pressure of 40 kg/cm² for 2-5 minutes, releasing steam for two times in the first minute, and the duration of the pressing is determined by the desired thickness of the semi-product;

4, grinding flash off the semi-product manually or with an electric grinding wheel to obtain a final product;

5, packaging the final product, and doing the packaging under an UV light if the final product needs to be sterilized, required facilities are UV disinfection device and packaging equipment.

Tests show that the product of the fourth embodiment of the present invention starts to grow mildew after 6 months being discarded in natural environment and 60-70% of the products can be degraded after one year. These products can pass the microwave oven and dishwasher tests and can be used repeatedly.

Examples of Tests:

1. dishwasher test

sample: 10 dishes

washing condition: washing/rinsing/drying (time of duration: 120 minutes at a temperature greater than 65 Celsius degrees)

cycles: 10

cleanser: CASCADE (90 grams)

dishwasher: KENMORE ULTRA WASH II

test result: after test, it can be seen by naked eyes that the surface texture of the dishes become coarse, and this is normal.

2. microwave oven test:

sample: 11 bowls each is filled with water which takes up 80% of the storage capacity of the respective bowls

microwave test: 1000 watts

microwave power: high

duration of microwave heating: 3 minutes

cycles: 10

test result: after test, it can be seen by naked eyes that the surface texture of the dishes become coarse, and this is normal.

While we have shown and described various embodiments in accordance with the present invention, it is clear to those skilled in the art that further embodiments may be made without departing from the scope of the present invention.

What is claimed is:

1. A soluble plant fiber product, comprising, by weight, the following ingredients:

| | | |
|---|---|---|
| plant fibrous powder: | 40-80% | by weight; |
| bonding agent | 2-40% | by weight; |
| demoulding agent | 5-15% | by weight; |
| starch | 5-40% | by weight. |

2. The soluble plant fiber product as claimed in claim 1 further comprising 0.1-2% by weight dye powder.

3. The soluble plant fiber product as claimed in claim 1, wherein the plant fibrous powder is selected from the group consisting of bamboo powder, wood powder, sugarcane bagasse, rice hull powder, reed residue and wheat bran.

4. The soluble plant fiber product as claimed in claim 1, wherein the bonding agent is selected from the group consisting of polyvinyl alcohol, poly-e-caprolactone, hydroxypropyl methylcellulose, epoxy resin, amino resin, phenolic resin.

5. The soluble plant fiber product as claimed in claim 1, wherein the demoulding agent is selected from the group consisting of Calcium Stearate and zinc stearate.

6. The soluble plant fiber product as claimed in claim 2, wherein the dye powder is selected from the group consisting of chrome powder, cadmium powder, iron powder, cobalt powder, titanium powder, Prussian blue, carbon black, quinacridone, Quinacridone Magenta, Quinacridone Red, azo dye powder, hansa yellow, disazo yellow, Permanent Yellow, permanent red, Naphthol Red, aniline black, sbnigrosine spirit soluble, Oil-soluble Aniline Black, BW, oil blue, and Alkali blue.

7. The soluble plant fiber product as claimed in claim 1, wherein the product includes tableware, film or flower pot.

8. The soluble plant fiber product as claimed in claim 1, wherein a fineness of the plant fibrous powder is 40-100 mesh.

9. A method for making a soluble plant fiber product as claimed in claim 1, comprising the steps of:
weighing the respective ingredients and dehydrating at 60-80 Celsius degrees for 1-5 hours;
grinding the ingredients into powder and mixing them round;
pressing the resultant mixture into a semi-product; and
grinding flash off the semi-product to obtain a final product.

10. The soluble plant fiber product as claimed in claim 9 further comprising a disinfection step.
